(19) United States
(12) Patent Application Publication
(10) Pub. No.: US 2024/0251717 A1
(43) Pub. Date: Aug. 1, 2024

(54) PRUNING SHEARS WITH BRANCH HOOKS

(71) Applicant: Milwaukee Electric Tool Corporation, Brookfield, WI (US)

(72) Inventors: Brandon Michaud, Chicago, IL (US); Sara Marie Manulik, Chicago, IL (US); Adhish V. Umranikar, Chicago, IL (US); Justin T. Kornely, Janesville, WI (US)

(21) Appl. No.: 18/424,166

(22) Filed: Jan. 26, 2024

Related U.S. Application Data
(60) Provisional application No. 63/441,512, filed on Jan. 27, 2023.

(51) Int. Cl. A01G 3/08; A01G 23/095

(52) U.S. Cl. CPC A01G 3/081; A01G 23/095

(57) ABSTRACT

Pruning shear heads are provided. A pruning shear head includes a base portion; a blade movable relative to the base portion between an open position and a closed position; and a branch hook comprising a contoured interior face, the branch hook being movable relative to the base portion between an open position and a stowed position.

### CROSS-REFERENCE TO RELATED APPLICATIONS

The present application claims priority to U.S. Provisional Patent Application No. 63/441,512 filed on Jan. 27, 2023, the disclosure of which is incorporated by reference herein in its entirety.

### FIELD

The present disclosure relates generally to working tools, and more particularly, to working tools with retractable branch hooks.

### BACKGROUND

Various handheld and powered working tools may be connected to an elongate pole or shaft, e.g., to extend the reach of the working tool. The elongate pole or shaft may have a telescoping function to extend the reach of the tool head of the working tool to a desired length. By way of example, pruning shears allow users to cut branches, trim limbs, or otherwise prune bushes, trees or the like. However, based on the reach of the working tool and the position of a user, a user may move, rotate, or otherwise manipulate the working tool to adjust the pruning position. Moreover, the user may need to hook, grab, or pull branches or the like during operation.

Accordingly, improved branch hooks for handheld or powered working tools such as pruning shears are desired in the art. In particular, pruning shears which provide movable branch hooks would be advantageous.

### BRIEF DESCRIPTION

Aspects and advantages of the invention in accordance with the present disclosure will be set forth in part in the following description, or may be obvious from the description, or may be learned through practice of the technology.

In accordance with one embodiment, a pruning shear head is provided. The pruning shear head includes a base portion; a blade movable relative to the base portion between an open position and a closed position; and a branch hook comprising a contoured interior face, the branch hook being movable relative to the base portion between an open position and a stowed position.

In accordance with another embodiment, a pruning shear is provided. The pruning shear includes a pole; and a pruning shear head connected to the pole. The pruning shear head includes a base portion; a blade movable relative to the base portion between an open position and a closed position; and a branch hook comprising a contoured interior face, the branch hook being movable relative to the base portion between an open position and a stowed position.

In accordance with another embodiment, an extended reach pruning shear is provided. The extend reach pruning shear includes a pole having a first end and a second end and a pruning shear head connected to the first end of the pole. The pruning shear head comprises a base portion; a blade pivotably connected to the base portion and movable relative to the base portion between an open position and a closed position; a branch hook comprising a contoured interior face, the branch hook being pivotably connected to the base portion and movable relative to the base portion between an open position and a stowed position, wherein the branch hook is biased towards the stowed position; and a lock button configured to selectively lock the branch hook in the open position. The extended reach pruning shear further includes a housing connected to the second end of the pole, the housing comprises motor operable to actuate the blade; and an actuator, wherein actuation of the actuator causes the motor to actuate the blade.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 is a perspective view of a pruning shear in accordance with embodiments of the present disclosure;

FIG. 2A is a side view of a pruning shear head in accordance with embodiments of the present disclosure;

FIG. 2B is a bottom view of the pruning shear head illustrated in FIG. 2A in accordance with embodiments of the present disclosure;

FIG. 3 is a side view of a branch hook in an open position in accordance with embodiments of the present disclosure;

FIG. 4 is a perspective internal view of a pruning shear head in accordance with embodiments of the present disclosure; and

FIG. 5 is another perspective internal view of a pruning shear head in accordance with embodiments of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

As used herein, the term “working tool” is intended to refer to a device which is used to perform a work operation, such as cutting materials like wood, metal, concrete, grass, or the like; trimming objects like branches; biasing fluids like air and water; and the like. By way of non-limiting example, working tools can include pruning shears, hedge trimmers, chainsaws, circular saws, reciprocating saws, grinders, string trimmers, lawnmowers, edgers, blowers, vacuums, snow throwers, mixers, augers, pumps, pipe threaders, drills, and impact wrenches. While embodiments provided below are directed to pruning shears, one or more components of the pruning shears described below, such as the branch hook, may be utilized with one or more different types of power tools. Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

As used herein, the terms “actuate,” “movable,” and their variants are intended to refer to any physical manipulation of a component. Actuation or moving can include, for example, depressing, switching, or pushing a blade, hook, trigger, or button. Actuation or moving can also include, for example, reciprocating, rotating, or translating a working element such as one or more blades, saws, or bits.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, pruning shears and pruning shear heads disclosed herein include a cutting element comprising a blade that is movable relative to a base portion, the blade and base portion cooperate to prune (e.g., cut) limbs, branches or debris that is disposed between the two elements. The pruning shears and pruning shear heads disclosed herein further include a branch hook. The branch hook is movable between an open position and a stowed position. When in the open position, the branch hook can have a concave surface generally facing away from the cutting element, such as back towards the user. The branch hook can thus be used for hooking, grabbing, or moving debris. When in the stowed position, the branch hook is collapsed towards the pole to close off the hooking ability. Thus, when the branch hook is in the stowed position, the pruning shear head can be maneuvered without unintended snagging by the branch hook. The dual-feature cutting element and branch hook provide a pruning shear head that offers greater operational flexibility and possibilities for a user.

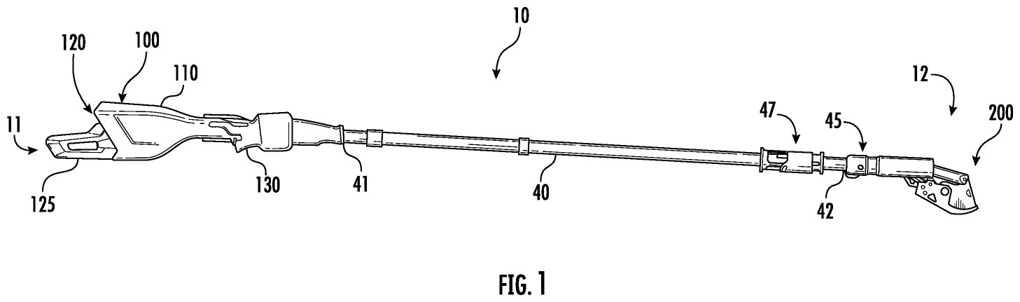

Referring now to the drawings, FIG. 1 illustrates a perspective view of a pruning shear 10 in accordance with an exemplary embodiment of the present disclosure. The pruning shear 10 can generally include a housing 100 at a first end 11 of the pruning shear 10 and a pruning shear head 200 at a second end 12 of the pruning shear 10, opposite the first end 11.

In some embodiments, the pruning shear 10 can further include a motive device 110 such as an electric motor or a gas engine. For instance, in the depicted embodiment, the housing 100 of the pruning shear 10 includes a battery receiving area 120 which receives a battery 125 to power an electric motor. An electric motor can thereby drive the pruning shear head 200. Alternatively, the pruning shear 10 may be a manually powered working tool without a motive device 110 to power the pruning shear head 200.

The pruning shear head 200 can be functionally connected to the housing 100, and the motive device 110, through a variety of potential configurations. For instance, as illustrated in FIG. 1, the pruning shear 10 may comprise a pole 40 between the housing 100 and the pruning shear head 200. In such embodiments, the pruning shear 10 may be referred to as an extended reach pruning shear. For instance, as illustrated in FIG. 1, the pole 40 may comprise a telescoping feature 47 configured to telescopically extend or retract the length of the pole 40. Alternatively, the pole 40 may be extendable or retractable through any other suitable mechanical means.

The pole 40 can comprise a variety of configurations to physically and functionally connect the pruning shear head 200 with the housing 100, while also distancing the pruning shear head 200 from the housing 100. For instance, as illustrated in FIG. 1, the pole 40 can comprise an elongated linear structure that extends from a first end 41 to a second end 42. The first end 41 can be connected or attached to the housing 100 through one or more clamps, screws, bolts or other securing devices. The second end 42 can be connected to the pruning shear head 200. One or more connection elements may travel through the pole to functionally connect the housing 100 with the pruning shear head 200, such as wires, linkage arms, axles, or the like.

In some embodiments, the pole 40 may comprise a non-linear configuration and/or a movable configuration to provide more positioning or maneuverability options between the housing 100 and the pruning shear head 200.

The pole 40 can be a separable element from the pruning shear head 200 and/or the housing 100, or can be an integral extension from one or both of the pruning shear head 200 and housing 100. Moreover, the pole 40 can, for example, comprise a hollow interior that allows one or more mechanical or electrical connections between the housing 100 and the pruning shear head 200. For instance, if the motive device is disposed in the housing 100, an axle or similar device may extend down the pole 40 to translate actuation (e.g., rotational motion) from the motive device to the pruning shear head 200. Alternatively, if the motive device were disposed at, near, or on the pruning shear head 200, a power and/or communication coupling (e.g., wires or cables) may extend down the pole 40 to translate electrical power and/or control signals from the housing for operating the pruning shear head 200.

In some embodiments, such as that illustrated in FIG. 1, the pole 40 may comprise an attachment feature 45 for selectively attaching the pruning shear head 200 thereto. For instance, the attachment feature 45 may selectively receive and secure the pruning shear head 200, either in a fixed relationship, or at one of a plurality of orientations through rotational flexibility and selective clamping. Thus, the pruning shear head 200 can be selectively positioned by the user prior to operation to put the pruning shear head 200 in a linear configuration (as illustrated) that is aligned with the pole 40, or in an offset configuration wherein the elongated blade assembly deviates from the pole 40 at an angle.

For operation of the pruning shear head 200, the pruning shear 10 may comprise an actuator 130. For instance, as illustrated in FIG. 1, the housing 100 of the pruning shear 10 may comprise the actuator 130. The actuator 130 can be any component configured to selectively activate the motive device 110 such that the motive device 110 actuates (e.g., closes or opens) a blade of the pruning shear head 200. The actuator 130 can comprise a trigger (as illustrated) or other suitable component such as a button, knob, wheel, or sensor. As such, the operator of the pruning shear 10 may grip the housing 100 via a handle portion while conveniently operating the pruning shear head 200 (e.g., opening and closing one or more blades of the pruning shear head for a cutting operation) via the actuator 130 disposed on the handle of the housing 100. In some embodiments, the actuator 130 may actuate the blade without the use of an intermediate motive device 110.

In some embodiments, the housing 100 may further comprise a safety trigger (not illustrated) that acts in cooperation with the actuator 130 to operate the motive device 110. For instance, the safety trigger may need to be depressed or otherwise selected before the actuator 130 can be actuated. The safety trigger can thereby inhibit inadvertent or undesired operation of the pruning shear head from accidental interaction with the actuator 130. The safety trigger can be disposed on the handle portion of the housing 100 similar to the actuator 130 to facilitate single handed control operations of the pruning shear. For instance, the actuator 130 may be disposed on a bottom side of the housing 100 while the safety trigger can be located on the top side of the housing 100, opposite the actuator 130. As such, an operator may naturally depress the safety trigger when gripping the handle portion. The operator may then selectively depress the actuator 130 in a trigger like configuration while remaining gripped on the handle portion of the housing 100. However, it should be appreciated, that additional or alternative configurations of the actuator 130, safety trigger, or other components may also be realized within the scope of this disclosure.

The pruning shear head 200, can generally comprise the working end of the pruning shear 10. That is the, the pruning shear head 200 can generally be configured to prune (e.g., cut, slice, chop, or otherwise separate) an object such as a branch or tree limb.

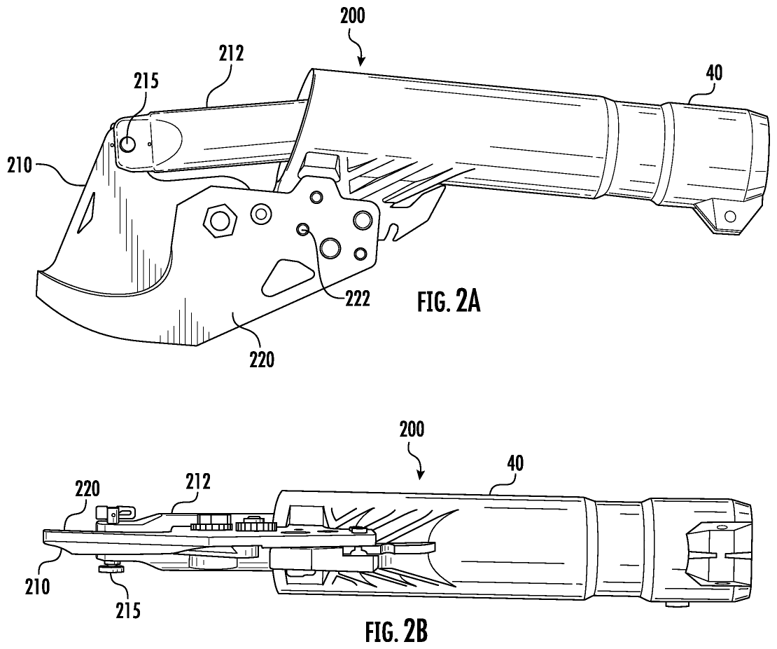

With reference to FIGS. 2A and 2B, a side view (FIG. 2A) and bottom view (FIG. 2B) of the pruning shear head 200 is illustrated in accordance with an exemplary embodiment of the present disclosure, such as for use in the pruning shear 10 illustrated in FIG. 1.

The pruning shear head 200 generally includes a base portion 220 and a blade 210 that is movable relative to the base portion 220. The blade 210 and the base portion 220 can thereby cooperate to selectively perform a pruning operation on an object disposed between the blade 210 and the base portion 220. That is, the blade 210 may be movable between an open position and a closed position, wherein an object can be disposed between the blade 210 and the base portion 220 when the blade 210 is in the open position. Subsequently, as the blade 210 transitions from the open position to the closed position (such that the blade 210 moves towards the base portion 220), the object disposed therebetween can be cut.

In some embodiments, such as that illustrated in FIGS. 2A and 2B, the base portion 220 can be fixed in place. For instance, the base portion 220 may be fixed to the pole 40 (or an intermediary attachment section) such that the base portion 220 and the pole 40 have a fixed and static spatial relationship to one another. The base portion 220 may thereby be mounted to the pole 40 or other component through any suitable means. In some embodiments, the base portion 220 may be mounted using one or more bolts 222. In some embodiments, the base portion 220 may be mounted using one or more screws, rivets, clamps, or the like. Alternatively, the base portion 220 may be configured to be actuatable in one or more directions. For instance, the base portion 220 may be pivotable with respect to the pole 40, the blade 210, or a combination thereof. For instance, the base portion 220 may be pivotable towards the blade 210 such that the both the base portion 220 and the blade 210 converge towards one another when pruning.

The base portion 220 can comprise an edge or face that faces the blade 210 to facilitate pruning therebetween. In some embodiments, the base portion 220 may comprise a flat or blunt structure that simply provides a backing for an object to rest against. However, in some embodiments, the base portion 220 may also comprise a blade such that a sharp edge of the base portion 220 also provides a cutting force on an object being pruned by the pruning shear head 200.

The blade 210 is movable relative to the base portion 220 between an open position and a closed position (illustrated in FIG. 2A). The blade 210 is more distal from the base portion 220 in the open position than when in the closed position such that a space is created between the blade 210 and the base portion 220 when the blade 210 is in the open position. Thus, when in the open position, an object may be disposed between the blade 210 and the base portion 220 for pruning. The blade 210 can than move to the closed position to prune (e.g., cut) the object between the blade 210 and the base portion 220. As best illustrated in FIG. 2A, in the closed position, the blade 210 (or at least a cutting edge thereof) may overlap with the base portion 220. Alternatively, in the closed position, the blade 210 (or at least a cutting edge thereof) may simply abut against the base portion.

The blade 210 may have any suitable cutting configuration for pruning an object. For instance, the blade 210 may have a curved profile such as a convex profile with an outer curve that faces the base portion 220. Moreover, the blade 210 may have a cutting edge having a V-Edge profile, convex edge profile, hollow edge profile, chisel edge profile, or variants or combinations thereof.

To facilitate movement of the blade 210 relative to the base portion 220, the blade 210 may have one or more pivotable connects with adjacent components. For instance, the blade 210 may have a pivotable connection with the base portion 220 such as via a pinned connection, a geared connection, or a combination thereof.

To blade 210 may also be connected to one or more components for controlling movement of the blade 210 relative to the base portion 220. For instance, the blade 210 may be pivotably connected to an elongated arm 212 such as by a pin 215. The elongated arm 212 may extend from the blade 210 towards the housing 100 (FIG. 1) such that a user may manually articulate the elongated arm 212, or a motive device 110 (FIG. 1) may articulate the elongated arm 212. For instance, as illustrated in FIG. 2A, the elongated arm 212 may extend down at least a portion of the interior of the pole 40.

In operation, the elongated arm 212 can be pulled towards the housing 100 (FIG. 1), such as being retracted into the pole 40, to pull the blade 210 away from the base portion 220 and into the open position. Then, the elongated arm 212 can be pushed away from the housing (100), such as being extended from the pole 40, to push the blade 210 towards the base portion 220 and into the closed position. As the elongated arm 212 is articulated back-and-forth, the blade 210 can pivot about the pin 215 or other pivotable connection with the elongated arm 212. When the blade has a second pivotable connection with the base portion 220 (i.e., in addition to the pivotable connection with the elongated arm 212), the blade may independently pivot with respect to both the base portion 220 and the elongated arm 212 when transitioning between the open and closed positions.

When operating the pruning shear, the pruning shear head 200 may be at an extended reach location away from the user. For instance, the pruning shear head 200 may be extended into a tree or where a user may not otherwise be able to personally reach. In these situations, it may become advantageous to move, rotate, or otherwise manipulate the working tool to adjust the pruning position. Moreover, the user may need to hook, grab, or pull branches or the like during operation to clear loose debris, move obstructed objects, secure or rest the pruning shear, or otherwise manipulate the distal foliage. To aid in this endeavor, the pruning shear head 200 may further include a branch hook.

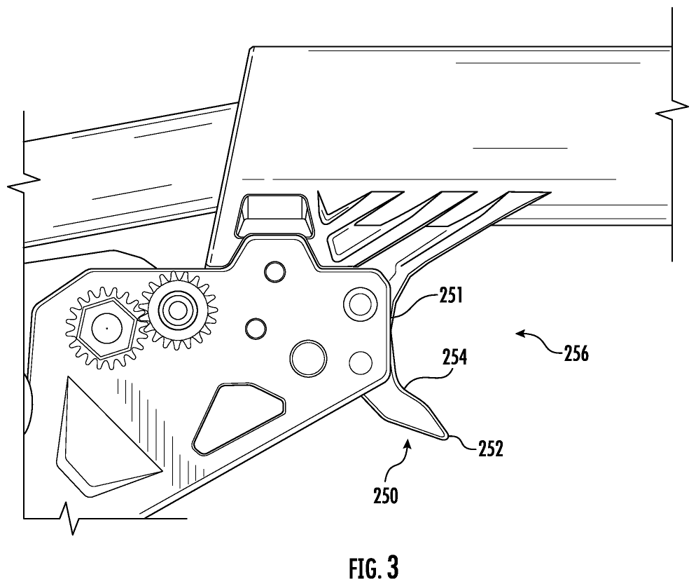

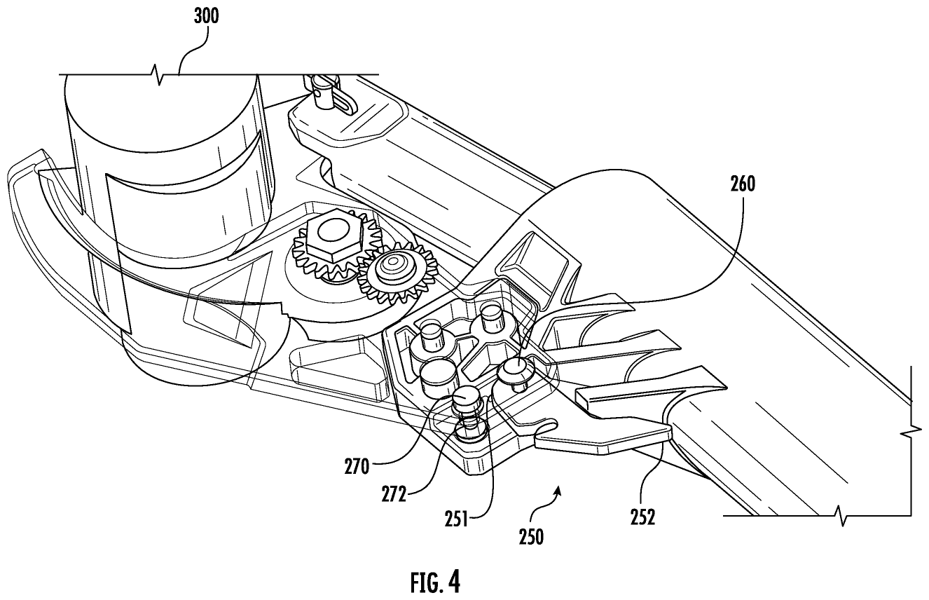

With additional reference to FIG. 3, a side view of the branch hook 250 is illustrated. With further reference to FIG. 4, a perspective internal view of the pruning shear head 200 is illustrated with the outer wall removed to showcase internal componentry supporting the branch hook 250. The branch hook 250 can be movable relative to the base portion 220 or other components between an open position (as illustrated in FIG. 3) and a stowed position (as illustrated in FIG. 4).

The branch hook 250 can generally comprise an elongated member that extends from a first end 251 to a second end 252. The first end 251 can be connected to the base portion 220, pole 40, and/or other components of the pruning shear head. The second end 252 can be a free end that is not connected to any adjacent components. The branch hook 250 may further include a contoured interior face 254 that extends between the first end 251 and the second end 252. The contoured interior face 254 can comprise any shape suitable for hooking branches or the like. For instance, as illustrated in FIG. 3, the contoured interior face 254 may be configured as a concave surface. The concave surface may face away from the base portion 220 (e.g., towards the housing 100 illustrated in FIG. 1) when in the open position as illustrated.

When in the open position (as illustrated in FIG. 3), the second end 252 of the branch hook 250 is disposed farther away from the pole 40 than when the branch hook 250 is in the stowed position (as illustrated in FIG. 4). Thus, in the open position, the contoured interior face 254 of the branch hook 250 partially defines an interior hooking space 256 configured to hook onto branches or the like dispose therein. When in the stowed position, the second end 252 of the branch hook 250 can be positioned closer to the pole 40 such that the contoured interior face 254 of the branch hook 250 faces the pole. The stowed position can prevent unwanted snagging of the branch hook 250 when manipulating the pruning shear head around foliage.

To facilitate movement of the branch hook 250 relative to the base portion 220 (or other components of the pruning shear 10 as illustrated in FIG. 1), the branch hook 250 may have one or more pivotable connects with adjacent components. For instance, the branch hook may have a pivotable connection with the base portion 220 and/or pole 40 such as via a pinned connection, a geared connection, or a combination thereof.

For example, as best illustrated in FIG. 4, the branch hook 250 may be pivotably connected to the base portion 220 via a pin 260. As discussed herein, the base portion 220 may itself have a fixed connection to the pole 40, such that the branch hook is movable with respect to the pole 40, either directly or indirectly. In some embodiments, the pin 260 or other suitable connection may be integrated into both the base portion 220 and the pole 40 (such as via an auxiliary attachment frame disposed thereon).

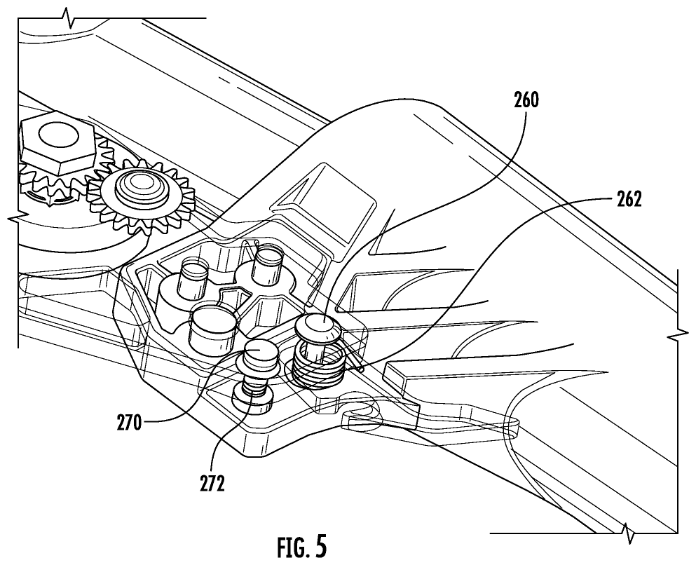

With additional reference to FIG. 5, another perspective internal view of the pruning shear head 200 is illustrated with the outer wall and branch hook removed to showcase internal componentry. In some embodiments, the branch hook 250 may be biased towards the stowed position. Such embodiments may promote the branch hook from always returning to the stowed position (absent a locking or other countering force) to facilitate streamlined movement of the pruning shear head. For instance, a torsion spring 262 may be used to bias the branch hook 250 towards the stowed position. The torsion spring 262 may be integrated around the pin 260 used to connect the branch hook 250 to the base portion 220 or other componentry.

With collective reference to FIGS. 4 and 5, in some embodiments, the branch hook may have a locking feature configured to selectively lock the branch hook 250 in the open position. For instance, the pruning shear head 200 may include a lock button 270 that selectively holds the branch hook 250 in place in the open position, either when actuated by a user or automatically when the branch hook 250 is moved into the open position. As illustrated, the lock button 270 may include a compression spring to facilitate the actuation of the lock button 270 and the locking force applied onto the branch hook 250. The user may then selectively release the branch hook 250 from the open position by (re)actuating the lock button 270.

Thus, in operation, the branch hook may be transitioned into the open position to create the interior hooking space 256 defined by the contoured interior face 254 of the branch hook 250. When in the open position, the user may actuate the lock button 270 which will provide a holding force on the branch hook 250 to maintain it in the open position. Alternatively, the lock button 270 may automatically implement the holding force when the branch hook is moved into the open position.

Subsequently, the user may actuate the lock button 270 to release the holding force it was providing. Upon that release, a biasing force (e.g., from a torsion spring 262 around the pin 260 that pivotably connects the branch hook 250) will automatically return the branch hook 250 to the stowed position next to the pole 40. The branch hook 250 can thereby provide selective positioning for temporary hooking utilization complimented by convenient storage for streamlined maneuverability of the pruning shear head.

Further aspects of the invention are provided by one or more of the following embodiments:

A pruning shear head includes a base portion; a blade movable relative to the base portion between an open position and a closed position; and a branch hook comprising a contoured interior face, the branch hook being movable relative to the base portion between an open position and a stowed position.

The pruning shear head of claim clause here, wherein the branch hook is pivotably connected to the base portion.

The pruning shear head of claim clause here, wherein the branch hook is biased towards the stowed position.

The pruning shear head of claim clause here, wherein a lock button is configured to selectively lock the branch hook in the open position.

The pruning shear head of claim clause here, wherein the contoured interior face comprises a concave surface.

The pruning shear head of claim clause here, wherein the concave surface faces away from the base portion when the branch hook is in the open position.

The pruning shear head of claim clause here, further comprising an elongated arm pivotably connected to the blade, wherein actuation of the elongated arm causes the blade to move between the open position and the closed position.

The pruning shear head of claim clause here, wherein the blade is pivotably connected to the base portion.

A pruning shear includes a pole; and a pruning shear head connected to the pole. The pruning shear head includes a base portion; a blade movable relative to the base portion between an open position and a closed position; and a branch hook comprising a contoured interior face, the branch hook being movable relative to the base portion between an open position and a stowed position.

The pruning shear of any clause herein, further comprising a housing connected to the pole, the housing comprising a motor operable to actuate the blade; and an actuator, wherein actuation of the actuator causes the motor to actuate the blade.

The pruning shear of any clause herein, further comprising an elongated arm that functionally connects the blade to the motor, wherein an elongated arm at least partially extends within the pole.

The pruning shear of any clause herein, wherein the blade is pivotably connected to the elongated arm.

The pruning shear of any clause herein, wherein the blade is also pivotably connected to the base portion.

The pruning shear of any clause herein, wherein the housing further comprises a battery receiving area.

The pruning shear of any clause herein, wherein the branch hook is pivotably connected to the base portion and/or the pole.

The pruning shear of any clause herein, wherein the branch hook is biased towards the stowed position.

The pruning shear of any clause herein, further comprising a lock button configured to selectively lock the branch hook in the open position.

The pruning shear of any clause herein, wherein the contoured interior face comprises a concave surface that faces away from the base portion when the branch hook is in the open position.

The pruning shear of any clause herein, wherein the pole comprises a telescoping feature.

An extended reach pruning shear includes a pole having a first end and a second end and a pruning shear head connected to the first end of the pole. The pruning shear head comprises a base portion; a blade pivotably connected to the base portion and movable relative to the base portion between an open position and a closed position; a branch hook comprising a contoured interior face, the branch hook being pivotably connected to the base portion and movable relative to the base portion between an open position and a stowed position, wherein the branch hook is biased towards the stowed position; and a lock button configured to selectively lock the branch hook in the open position. The extended reach pruning shear further includes a housing connected to the second end of the pole, the housing comprises motor operable to actuate the blade; and an actuator, wherein actuation of the actuator causes the motor to actuate the blade.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A pruning shear head, comprising:
a base portion;
a blade movable relative to the base portion between an open position and a closed position; and
a branch hook comprising a contoured interior face, the branch hook being movable relative to the base portion between an open position and a stowed position.

2. The pruning shear head of claim 1, wherein the branch hook is pivotably connected to the base portion.

3. The pruning shear head of claim 1, wherein the branch hook is biased towards the stowed position.

4. The pruning shear head of claim 3, wherein a lock button is configured to selectively lock the branch hook in the open position.

5. The pruning shear head of claim 1, wherein the contoured interior face comprises a concave surface.

6. The pruning shear head of claim 5, wherein the concave surface faces away from the base portion when the branch hook is in the open position.

7. The pruning shear head of claim 1, further comprising an elongated arm pivotably connected to the blade, wherein actuation of the elongated arm causes the blade to move between the open position and the closed position.

8. The pruning shear head of claim 1, wherein the blade is pivotably connected to the base portion.

9. A pruning shear, comprising:
a pole; and
a pruning shear head connected to the pole, the pruning shear head comprising:
a base portion;
a blade movable relative to the base portion between an open position and a closed position; and
a branch hook comprising a contoured interior face, the branch hook being movable relative to the base portion between an open position and a stowed position.

10. The pruning shear of claim 9, further comprising a housing connected to the pole, the housing comprising:
a motor operable to actuate the blade; and
an actuator, wherein actuation of the actuator causes the motor to actuate the blade.

11. The pruning shear of claim 10, further comprising an elongated arm that functionally connects the blade to the motor, wherein an elongated arm at least partially extends within the pole.

12. The pruning shear of claim 11, wherein the blade is pivotably connected to the elongated arm.

13. The pruning shear of claim 12, wherein the blade is also pivotably connected to the base portion.

14. The pruning shear of claim 10, wherein the housing further comprises a battery receiving area.

15. The pruning shear of claim 9, wherein the branch hook is pivotably connected to the base portion and/or the pole.

16. The pruning shear of claim 9, wherein the branch hook is biased towards the stowed position.

17. The pruning shear of claim 16, further comprising a lock button configured to selectively lock the branch hook in the open position.

18. The pruning shear of claim 9, wherein the contoured interior face comprises a concave surface that faces away from the base portion when the branch hook is in the open position.

19. The pruning shear of claim 9, wherein the pole comprises a telescoping feature.

20. An extended reach pruning shear, comprising:
a pole having a first end and a second end;
a pruning shear head connected to the first end of the pole, the pruning shear head comprising:
a base portion;
a blade pivotably connected to the base portion and movable relative to the base portion between an open position and a closed position;
a branch hook comprising a contoured interior face, the branch hook being pivotably connected to the base portion and movable relative to the base portion between an open position and a stowed position, wherein the branch hook is biased towards the stowed position; and
a lock button configured to selectively lock the branch hook in the open position; and
a housing connected to the second end of the pole, the housing comprising:
a motor operable to actuate the blade; and
an actuator, wherein actuation of the actuator causes the motor to actuate the blade.
